(19) United States
(12) Patent Application Publication
(10) Pub. No.: US 2026/0237292 A1
(43) Pub. Date: Aug. 13, 2026

(54) VEHICLE INTERACTIVE DEVICE IDENTIFICATION METHOD, SYSTEM, STORAGE MEDIUM AND INTELLIGENT REMOTE CONTROLLER

(71) Applicant: GOERTEK TECHNOLOGY CO., LTD, Qingdao, Shandong (CN)

(72) Inventor: Bei YANG, Qingdao, Shandong (CN)

(21) Appl. No.: 19/470,839

(22) PCT Filed: Dec. 3, 2024
(86) PCT No.: PCT/CN2024/136420

§ 371 Date: Sep. 30, 2025

(30) Foreign Application Priority Data
Dec. 5, 2023 (CN) 202311658722.1

(51) Int. Cl. G08C 21/00; B60K 35/80

(52) U.S. Cl. CPC G08C 21/00; B60K 35/80; G08C 2201/70; G08C 2201/91

(57) ABSTRACT

Disclosed are a vehicle interactive device identification method, system, storage medium and intelligent remote controller, pertaining to the field of vehicle interactive technology. The method includes: in response to an interactive command sent by an intelligent remote controller, determining a target orientation and a target operation area located in a vehicle for the intelligent remote controller respectively; performing matching according to a preset mapping relationship between an operation area and a device area in the vehicle, to obtain a valid device area of the intelligent remote controller in the target operation area; determining a target device area of the intelligent remote controller from the valid device area according to the target orientation; determining an interactive device in the target device area as a target device, and controlling the target device to respond to the interactive command. The low recognition accuracy of interactive devices in vehicles in related art are solved.

The present disclosure claims a priority to the Chinese patent application No. 202311658722.1, entitled “Vehicle Interactive Device Identification Method, System, Storage Medium and Intelligent remote controller”, filed to the China Patent Office on Dec. 5, 2023, all contents of which are incorporated herein by reference.

### TECHNICAL FIELD

The present disclosure relates to the field of vehicle interaction technology, and specifically, to a vehicle interactive device identification method, system, storage medium and intelligent remote controller.

### DESCRIPTION OF RELATED ART

With the development of vehicle technology, people have put forward higher requirements for the convenience and interactivity of vehicles; therefore, how to provide users with a safe and convenient interaction method has become the main research direction of various companies and institutions in the industry.

The conventional method to interact with a device is to set up an infrared remote controller and then send infrared commands through the infrared remote controller to interact; however, this method requires the installation of an infrared receiver on the device side. At the same time, if there are people or other obstructions in the direction of sending the remote controller's command, it is difficult to accurately identify the target interactive device, resulting in low accuracy in identifying the interactive device.

The above contents are only used to assist in understanding the technical solution of the present disclosure and do not constitute an admission that the above contents are prior art.

### SUMMARY

The main purpose of this application is to provide a vehicle interactive device identification method, system, storage medium and intelligent remote controller, aiming to solve the technical problem of low recognition accuracy of interactive devices on vehicles in conventional methods.

To achieve the above object, the present disclosure provides a vehicle interactive device identification method, wherein the vehicle interactive device identification method includes following steps:
in response to an interactive command sent by an intelligent remote controller, determining a target orientation and a target operation area located in a vehicle for the intelligent remote controller respectively;
performing matching according to a preset mapping relationship between an operation area and a device area in the vehicle, to obtain a valid device area of the intelligent remote controller in the target operation area;
determining a target device area of the intelligent remote controller from the valid device area according to the target orientation; and
determining an interactive device in the target device area as a target device, and controlling the target device to respond to the interactive command.

Optionally, before the responding to the interactive command sent by the intelligent remote controller, the method further includes:
identifying interactive devices in the vehicle; and
dividing the vehicle into a plurality of device areas according to spatial positions of each of the interactive devices in the vehicle.

Optionally, after the dividing the vehicle into the plurality of device areas according to spatial positions of each of the interactive devices in the vehicle, the method further includes:
identifying a window area and a rearview mirror area in the device area;
determining a maximum overlapping portion of the window area being overlapped with a projection in a first preset direction of the rearview mirror area, wherein the first preset direction is a direction from a cabin of the vehicle toward an outside of the vehicle;
modifying the window area according to the maximum overlapping portion to prevent the rearview mirror area from being obstructed by the window area.

Optionally, the device area of the vehicle includes one or more selected from a group consisting of: a multimedia area, an air-conditioning area, a rearview mirror area, a glove box area, an ambient light area, a reading light area, a sunroof area, a seat area, a window area and a trunk area.

Optionally, the operation area of the vehicle includes one or more selected from a group consisting of a driver's operation area, a front passenger's operation area and a back passenger's operation area.

Optionally, the determining a target device area of the intelligent remote controller from the valid device area according to the target orientation includes:
generating a first orientation ray according to the target orientation; and
determining a valid device area through which the first orientation ray passes and having a shortest distance from a starting point of the first orientation ray, as the target device area.

Optionally, before the generating a first orientation ray according to the target orientation, the method further includes:
determining whether the target orientation is consistent with a preset seat adjustment direction;
if not, performing the generating a first orientation ray according to the target orientation;
if yes, generating two second orientation rays by extending bidirectionally based on the target orientation when the intelligent remote controller is located in a seat adjustment area in the target operation area, wherein the two second orientation rays have the same starting point; and
determining a valid device area through which the second orientation rays pass and having a shortest distance from the starting point of the second orientation rays, as the target device area.

Optionally, at least one positioning device is provided at each of front and rear ends of the intelligent remote controller, and identification numbers of the positioning devices are different from each other, and wherein the determining a target orientation and a target operation area in the vehicle for the intelligent remote controller respectively includes:
acquiring coordinate information of each of the positioning devices, wherein the coordinate information encapsulates the identification numbers of the positioning devices;
determining the target operation area where the intelligent remote controller is located according to the coordinate information; and
determining a front point and a rear point of the intelligent remote controller according to the coordinate information, and determining a direction from the rear point to the front point as the target orientation.

The present disclosure also provides a vehicle interactive device identification system, including an intelligent remote controller and a control terminal, wherein the intelligent remote controller is communicatively connected with the control terminal, wherein the vehicle interactive device identification system includes:
the intelligent remote controller configured to transmit an interactive command to the control terminal in response to a user's operation; and
the control terminal configured to:
in response to an interactive command sent by an intelligent remote controller, determine a target orientation and a target operation area located in a vehicle for the intelligent remote controller respectively;
perform matching according to a preset mapping relationship between an operation area and a device area in the vehicle, to obtain a valid device area of the intelligent remote controller in the target operation area;
determine a target device area of the intelligent remote controller from the valid device area according to the target orientation; and
determine an interactive device in the target device area as a target device and control the target device to respond to the interactive command.

The present disclosure also provides an intelligent remote controller, wherein the intelligent remote controller includes: a memory, a processor, and a vehicle interactive device identification program stored in the memory and executable by the processor, wherein the vehicle interactive device identification program is configured to implement the steps of the vehicle interactive device identification method as described above.

The present disclosure provides a storage medium having a vehicle interactive device identification program stored thereon, the vehicle interactive device identification program is executed by a processor to implement the steps of the vehicle interactive device identification method as described above.

The present disclosure discloses a vehicle interactive device identification method, which in response to an interactive command sent by an intelligent remote controller, determines a target orientation of an intelligent remote controller and a target operation area of an intelligent remote controller in a vehicle respectively; then, performs matching according to the preset mapping relationship between the operation area and the device area in the vehicle, to obtain a valid device area of the intelligent remote controller in the target operation area; determines the target device area of the intelligent remote controller from the valid device area according to the target orientation; and determines the interactive device in the target device area as the target device, and controls the target device to respond to the interactive command. Through the setting of the intelligent remote controller, users at various positions in the vehicle can interact with the interactive device in the vehicle, thereby improving the convenience of human-vehicle interaction, especially the convenience of the interaction in multi-passengers scenarios, being able to meet the interactive needs of passengers at all positions in the vehicle, and improving the user experience; and by pre-dividing the vehicle into spatial areas, the device areas and the operation areas where the interactive devices (for example, air conditioners, windows, multimedia, etc. in the vehicle) are respectively located in the vehicle; furthermore, performing matching according to the preset mapping relationship between the operation area and the device area in the vehicle, to obtain the valid device area of the intelligent remote controller in the target operation area; performing the restrictions to controllable interactive devices on the intelligent remote controller located in different operation areas of the vehicle to avoid such a case, for example, that traffic accidents occur because the passenger controls the vehicle's mirror by the intelligent remote controller; ensuring driving safety while meeting user's interaction needs; moreover, determining the target device area based on the orientation of the intelligent remote controller to further accurately identify the target device from multiple interactive devices in the vehicle; identifying the target device based on the orientation of the intelligent remote controller when the intelligent remote controller sends interactive command, therefore it can avoid device recognition failures due to obstruction of infrared signals or other light signals by passengers or other obstructions, thereby improving the accuracy of vehicle interactive device recognition; by means of the interaction between the control terminal and the intelligent remote controller, there is no need to install command receiver on each of the interactive devices of the vehicle respectively, and the interaction with each of the interactive devices on the vehicle can be achieved, reducing the vehicle implementation cost.

### BRIEF DESCRIPTION OF DRAWINGS

FIG. 1 is a schematic diagram of the configuration of an intelligent remote controller in a hardware operating environment according to an embodiment of the present disclosure;

FIG. 2 is a schematic flow chart of a vehicle interactive device identification method according to an embodiment of the present disclosure;

FIG. 3 is a schematic diagram of a scenario according to a first embodiment of the present disclosure;

FIG. 4 is a schematic diagram of the device area according to a second embodiment of the present disclosure;

FIG. 5 is a schematic diagram of a projection overlapping scenario according to the second embodiment of the present disclosure;

FIG. 6 is a schematic diagram of an operation area according to the second embodiment of the present disclosure;

FIG. 7 is a schematic diagram of another operation area according to the second embodiment of the present disclosure;

FIG. 8 is a schematic diagram of a scenario according to a third embodiment of the present disclosure;

FIG. 9 is a schematic diagram of a seat adjustment direction according to the third embodiment of the present disclosure;

FIG. 10 is a schematic diagram of a seat adjustment area according to the third embodiment of the present disclosure;

FIG. 11 is a schematic diagram of a second orientation ray according to the third embodiment of the present disclosure.

The realization of the purpose, functional features and advantages of this application will be further explained in conjunction with embodiments and with reference to the accompanying drawings.

### DETAILED DESCRIPTIONS

It should be understood that the specific embodiments described herein are only used to explain the present disclosure and are not used to limit the present disclosure.

In addition, the descriptions of “first”, “second”, etc. in this application are only for descriptive purposes and cannot be understood as indicating or implying their relative importance or implicitly indicating the number of technical features indicated. Therefore, the features defined as “first” and “second” may explicitly or implicitly include at least one of the features. In addition, “and/or” in the full text includes three solutions. Taking A and/or B as an example, it includes technical solution A, technical solution B, and technical solution that satisfies both A and B; in addition, the technical solutions between the various embodiments can be combined with each other, but it must be based on the ability of ordinary technicians in this field to implement. When the combination of technical solutions is contradictory or cannot be implemented, it should be deemed that such combination of technical solutions does not exist and is not within the scope of protection required by this application.

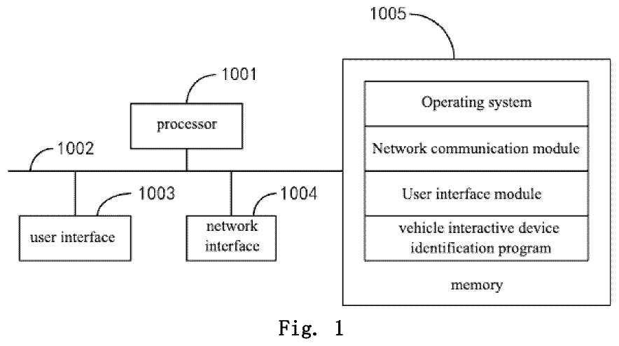

Refer to FIG. 1, which is a schematic diagram of the configuration of an intelligent remote controller in the hardware operating environment according to an embodiment of the present disclosure.

As shown in FIG. 1, the intelligent remote controller may include: a processor 1001, such as a central processing unit (CPU), a communication bus 1002, a user interface 1003, a network interface 1004, and a memory 1005. The communication bus 1002 is used to realize the connection and communication between these components. The user interface 1003 may include a display screen (Display), an input unit such as a keyboard (Keyboard), and the optional user interface 1003 may further include a standard wired interface and a wireless interface. The network interface 1004 may optionally include a standard wired interface and a wireless interface (such as a wireless fidelity (Wireless-Fidelity, WI-FI) interface). The memory 1005 may be a high-speed random access memory (Random Access Memory, RAM) memory, or a stable non-volatile memory (Non-Volatile Memory, NVM), such as a disk memory. The memory 1005 may also be a storage device independent of the aforementioned processor 1001.

Those skilled in the art will appreciate that the configuration shown in FIG. 1 does not constitute a limitation on the intelligent remote controller, and may include more or fewer components than shown in the figure, or a combination of certain components, or a different arrangement of components.

As shown in FIG. 1, the memory 1005 as a storage medium may include an operating system, a data storage module, a network communication module, a user interface module, and a vehicle interactive device identification program.

In the intelligent remote controller shown in FIG. 1, the network interface 1004 is mainly used for data communication with other devices; the user interface 1003 is mainly used for data interaction with the user; the processor 1001 and the memory 1005 in the intelligent remote controller of the present disclosure can be arranged in the intelligent remote controller, and the intelligent remote controller calls the vehicle interactive device identification program stored in the memory 1005 through the processor 1001, and performs the following operations:
in response to an interactive command sent by an intelligent remote controller, determining a target orientation and a target operation area located in a vehicle for the intelligent remote controller respectively;
performing matching according to a preset mapping relationship between an operation area and a device area in the vehicle, to obtain a valid device area of the intelligent remote controller in the target operation area;
determining a target device area of the intelligent remote controller from the valid device area according to the target orientation; and
determining an interactive device in the target device area as a target device, and controlling the target device to respond to the interactive command.

Furthermore, the processor 1001 may call the vehicle interactive device identification program stored in the memory 1005, to further perform the following operations:
before responding to the interactive command sent by the intelligent remote controller, further including:
identifying interactive devices in the vehicle; and
dividing the vehicle into a plurality of device areas according to spatial positions of each of the interactive devices in the vehicle.

Furthermore, the processor 1001 may call the vehicle interactive device identification program stored in the memory 1005, to further perform the following operations:
after the dividing the vehicle into the plurality of device areas according to spatial positions of each of the interactive devices in the vehicle, further including:
identifying a window area and a rearview mirror area in the device area;
determining a maximum overlapping portion of the window area being overlapped with a projection in a first preset direction of the rearview mirror area, wherein the first preset direction is a direction from a cabin of the vehicle toward an outside of the vehicle; and
modifying the window area according to the maximum overlapping portion to prevent the rearview mirror area from being obstructed by the window area.

Furthermore, the device area of the vehicle includes one or more selected from a group consisting of: a multimedia area, an air-conditioning area, a rearview mirror area, a glove box area, an ambient light area, a reading light area, a sunroof area, a seat area, a window area and a trunk area.

Furthermore, the operation area of the vehicle includes one or more selected from a group consisting of a driver's operation area, a front passenger's operation area and a back passenger's operation area.

Furthermore, the determining the target device area of the intelligent remote controller from the valid device area according to the target orientation includes:
generating a first orientation ray according to the target orientation; and
determining the valid device area through which the first orientation ray passes and having a shortest distance from a starting point of the first orientation ray, as the target device area.

Furthermore, the processor 1001 may call the vehicle interactive device identification program stored in the memory 1005 to further perform the following operations:
before the generating a first orientation ray according to the target orientation, further including:
determining whether the target orientation is consistent with a preset seat adjustment direction;
if not, performing the generating a first orientation ray according to the target orientation;
if yes, generating two second orientation rays by extending bidirectionally based on the target orientation when the intelligent remote controller is located in a seat adjustment area in the target operation area, wherein the two second orientation rays have the same starting point; and
determining the valid device area through which the second orientation rays pass and having a shortest distance from the starting point of the second orientation rays, as the target device area.

Furthermore, at least one positioning device is provided at each of front and rear ends of the intelligent remote controller, and identification numbers of the positioning devices are different from each other, and the determining a target orientation and a target operation area located in a vehicle for the intelligent remote controller respectively includes:
acquiring coordinate information of each of the positioning devices, wherein the coordinate information encapsulates the identification numbers of the positioning devices;
determining the target operation area where the intelligent remote controller is located according to the coordinate information; and
determining a front point and a rear point of the intelligent remote controller according to the coordinate information, and determining a direction from the rear point to the front point as the target orientation.

Based on the above configuration, various embodiments of the vehicle interactive device identification method are proposed.

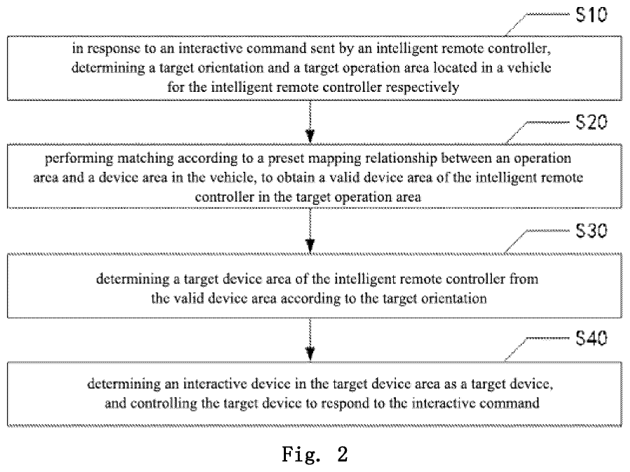

Refer to FIG. 2, which is a schematic flow chart of a first embodiment of a vehicle interactive device identification method of the present disclosure.

In this embodiment, the subject of executing the vehicle interactive device identification method may be an intelligent remote controller, which is a device that can send interactive commands. The subject of executing the method may be a separate newly added physical device, or a device that implements the sending of interactive commands by adding corresponding hardware and software modules to existing devices (e.g., car keys, mobile phones, etc.). The subject of executing the method may also be a control terminal, which may be a local device, such as the vehicle's console system, electronic control unit (ECU, Electronic Control Unit), etc., or a mobile terminal such as a mobile phone or notebook, or a local device installed on the vehicle, which is used to respond to interactive commands sent by the remote control and control various interactive devices on the vehicle; the subject of executing the method may also be a network device, which is not limited in this embodiment. For the sake of ease of description, the description of performing operations of each embodiments by the subject of executing the method will be omitted. In this embodiment, the vehicle interactive device identification method includes:

Step S10, in response to an interactive command sent by an intelligent remote controller, determining a target orientation and a target operation area located in a vehicle for the intelligent remote controller respectively;

In response to the interactive command sent by the intelligent remote controller, obtaining the orientation information of the intelligent remote controller relative to the vehicle cabin, and furthermore determining the orientation of the intelligent remote controller when the intelligent remote controller sends the interactive command (hereinafter referred to as the target orientation in order for distinction) based on the orientation information, and determining the operation area in the vehicle where the intelligent remote controller is located when the intelligent remote controller sends the interactive command (hereinafter referred to as the target operation area in order for distinction).

Optionally, the orientation information can be obtained from the intelligent remote controller when an interactive command is received; the orientation information of the intelligent remote controller relative to the vehicle cabin can also be dynamically obtained and stored in the local through low-power methods such as background operating before the interactive command is received, furthermore, when the interactive command is received, the orientation information is directly retrieved from the backend to achieve a timely response to the interactive command.

Optionally, the vehicle interactive device identification method is applied to a vehicle, and the vehicle includes a plurality of interactive devices; the interactive devices can be various functional devices provided on the vehicle, such as air conditioner, audio and video entertainment systems (multimedia), seats, trunk, sunroof, windows, etc., which are not limited in this embodiment; the user can use the intelligent remote controller to send interactive commands to various interactive devices on the vehicle at any location in the vehicle cabin, so that the human-computer interaction with the various interactive devices in the vehicle is no longer limited by the user's location, and the human-computer interaction with the vehicle's interactive devices can be achieved at any location in the vehicle cabin, which especially improves the convenience of interaction in multi-passengers scenarios, can meet the interaction needs of passengers at various positions in the vehicle, and enhances the user experience.

Optionally, the vehicle is divided into a plurality of interactive device areas (hereinafter referred to as device areas in order for distinction) in advance according to the spatial positions of the interactive devices on the vehicle, and each of the device areas comprises an interactive device; the target device for user interaction can be determined by identifying the device areas.

Exemplarily, the device area of the vehicle include: one or more of a multimedia area, an air-conditioning area, a rearview mirror area, a glove box area, an ambient light area, a reading light area, a sunroof area, a seat area, a window area and a trunk area.

Optionally, after the vehicle is divided into the device areas, the remaining area of the vehicle cabin can be used as the user's operation area, that is, the area where the user can move in the cabin; and according to each of the seats in the vehicle, the operation area can be further divided into for example, the driver's operation area, the front passenger's operation area, the back passenger's operation area, the public operation area, etc., which is not limited in this embodiment.

Optionally, a vehicle cabin coordinate system can be established with the vehicle cabin as a reference, furthermore the spatial coordinates of the intelligent remote controller in the vehicle cabin coordinate system, i.e., the coordinate information, can be determined, and the coordinate information can be used as the orientation information of the intelligent remote controller; moreover, the orientation of the intelligent remote controller in the vehicle can be determined based on the coordinate information.

In a feasible implementation, at least one positioning device is provided at each of the front and rear ends of the intelligent remote controller, and the identification numbers of the positioning devices are different. In step S10, in response to an interactive command sent by an intelligent remote controller, determining a target orientation and a target operation area located in a vehicle for the intelligent remote controller respectively, the step S10 includes:

Step S11, acquiring coordinate information of each of the positioning devices, wherein the coordinate information encapsulates the identification numbers of the positioning devices;

At least one positioning device is provided at each of the front and rear ends of the intelligent remote controller, and each of the positioning devices uses a different identification number. Thereby, according to identification numbers of the positioning devices encapsulated in the acquired coordinate information, the source of the coordinate information can be determined to distinguish the front and rear ends of the intelligent remote controller; furthermore, the coordinate information collected by the positioning devices can be obtained with reference to the vehicle cabin coordinate system; at least two coordinate points are included, and the coordinate points can be three-dimensional coordinate points.

Optionally, the positioning devices may be an antenna, and the antenna may be a UWB (Ultra Wide Band) antenna or a Bluetooth antenna. By arranging at least one antenna at each of the front and rear ends of the intelligent remote controller, the front and rear ends of the intelligent remote controller are determined by multi-antenna technology to determine the orientation of the intelligent remote controller.

Optionally, specific identification numbers can be set for the positioning devices at the front and rear ends of the intelligent remote controller in advance; exemplarily, a positioning device is set at each of the front and rear ends of the intelligent remote controller, and the positioning devices are UWB antennas, that is, the intelligent remote controller includes a front-end UWB antenna and a rear-end UWB antenna, thereby the identification number of the front-end UWB antenna is pre-set to 1, and the identification number of the rear-end UWB antenna is pre-set to 2; furthermore, after obtaining the coordinate information of each of the positioning devices, the source of the coordinate information can be determined by the identification number 1 or 2 encapsulated in the coordinate information.

Exemplarily, a positioning device is provided at each of the front and rear ends of the intelligent remote controller, and the positioning devices are Bluetooth antennas, that is, the intelligent remote controller includes: a front-end Bluetooth antenna and a rear-end Bluetooth antenna, and thereby the identification number of the front-end Bluetooth antenna is pre-set to A, and the identification number of the rear-end Bluetooth antenna is pre-set to B; furthermore, after obtaining the coordinate information of each of the positioning devices, the source of the coordinate information can be determined by the identification number A or B encapsulated in the coordinate information.

Step S12, determining the target operation area where the intelligent remote controller is located according to the coordinate information;

There are a plurality of operation areas pre-divided in the vehicle. The target operation area where the intelligent remote controller is located when the intelligent remote controller sends the interactive command can be determined according to the coordinate information of the intelligent remote controller.

Exemplarily, the pre-divided operation areas in the vehicle include: the driver's operation area, the front passenger's operation area, and the first back passenger's operation area, the second back passenger's operation area, and the third back passenger's operation area in the back rows; the coordinate information of the intelligent remote controller is in the front passenger's operation area, and thereby the target operation area is determined to be the front passenger's operation area, that is, the passenger sitting on the front passenger's seat is using the intelligent remote controller to interact with the interactive device in the vehicle.

Step S13, determining a front point and a rear point of the intelligent remote controller according to the coordinate information, and determining a direction from the rear point to the front point as the target orientation.

The front point and the rear point of the intelligent remote controller in the vehicle cabin coordinate system are determined according to the identification number encapsulated in the acquired coordinate information; and thereby the direction from the rear point to the front point is determined as the target orientation.

Optionally, the front point may be the front end point of the intelligent remote controller, and the rear point may be the rear end point of the intelligent remote controller; the front point may also be the rear end point of the intelligent remote controller, and the rear point may also be the front end point of the intelligent remote controller, which is not limited in this embodiment.

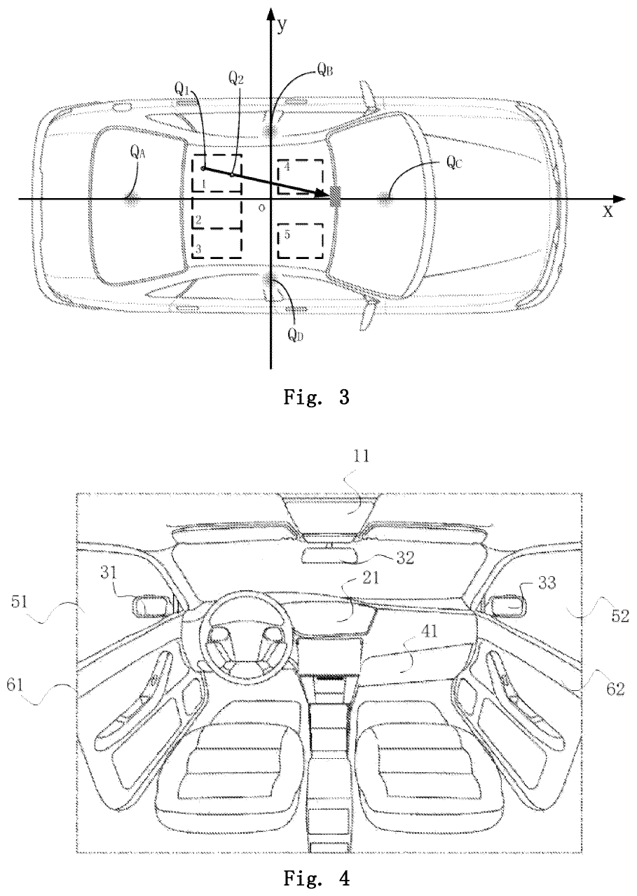

Exemplarily, referring to FIG. 3, a vehicle cabin coordinate system is established with the center point of the vehicle cabin as the origin (the vehicle cabin coordinate system can be a three-dimensional coordinate system or a two-dimensional coordinate system, and the present embodiment takes a three-dimensional coordinate system as an example), and UWB anchor points, namely, four points Q_{A}, Q_{B}, Q_{C} and Q_{D}, are set at four positions in the vehicle cabin. The dotted square in FIG. 3 is the operation area of the vehicle, and each seat in the vehicle cabin corresponds to one operation area, 5 operation areas are included, and each operation area corresponds to one identification number, namely 1-5; thereby UWB antennas, namely Q₁ and Q₂, are respectively set at the front and rear ends of the intelligent remote controller, and the coordinate information of Q₁ and Q₂ is determined by setting UWB anchor points in the vehicle; Q₁ and Q₂ are located in operation area 1, that is, operation area 1 is the target operation area; thereby the rear point Q₁ is taken as the initial point, and the direction towards the front point Q₂ is taken as the target orientation. The target device area of the intelligent remote controller can be determined according to the target orientation, and thereby the target device is determined.

In this embodiment, at least one positioning device is provided at each of the front and rear ends of the intelligent remote controller, and each of the positioning devices uses a different identification number, thereby obtaining the coordinate information of each of the positioning devices, wherein the identification number of the positioning device is encapsulated in the coordinate information; The target operation area where the intelligent remote controller is located is determined according to the coordinate information; the front point and the rear point of the intelligent remote controller are determined according to the coordinate information, and the direction from the rear point to the front point is determined as the target orientation. This realizes accurate identification of the operation area and orientation of the intelligent remote controller in the vehicle.

Step S20, performing matching according to a preset mapping relationship between an operation area and a device area in the vehicle, to obtain a valid device area of the intelligent remote controller in the target operation area;

The valid device area of the intelligent remote controller in the target operation area is obtained by performing matching through the preset mapping relationship between the operation area and the device area in the vehicle; the controllable interactive devices of the intelligent remote controller located in different operation areas of the vehicle are restricted, that is, the permissions of each operation area are set, thereby avoiding, for example, traffic accidents occur because the passengers controls the vehicle's mirror through the intelligent remote controller; driving safety is ensured while meeting user interaction needs.

Exemplarily, the operation areas include: a driver's operation area and a back passenger's operation area, and the device areas include: a multimedia area, an air-conditioning area and a rearview mirror area. According to a preset mapping relationship between the operation areas and the device areas in the vehicle, it is determined that the effective device areas of the driver's operation area include: a multimedia area, an air-conditioning area and a rearview mirror area; and the effective device areas of the back passenger's operation area include: a multimedia area and an air-conditioning area; that is, the interactive device (mirror) in the rearview mirror area cannot be controlled by using the intelligent remote controller in the back passenger's operation area, thereby avoiding traffic accidents occur because the passenger controls the vehicle's mirror through the intelligent remote controller, thereby ensuring driving safety.

Step S30, determining a target device area of the intelligent remote controller from the valid device area according to the target orientation;

A target device area of the intelligent remote controller is determined from a plurality of valid device areas according to the target orientation of the intelligent remote controller.

Step S40: determining an interactive device in the target device area as a target device, and controlling the target device to respond to the interactive command.

After determining the target device area, the interactive device in the target device area is taken as the target device to achieve accurate identification of the target device, and thereby control the target device to respond to the interactive command sent by the intelligent remote controller.

Optionally, if the control terminal is a main control system on a vehicle, then after determining the target device, the target device can be controlled to respond to the interactive commands through the CAN bus (controller area network bus), thereby enabling each interactive device on the vehicle to respond to the interactive commands sent by the intelligent remote controller on the condition of not installing an additional instruction receiving device, thereby reducing the implementation cost of the vehicle interactive device identification method; and the intelligent remote controller can interact with any vehicle through the vehicle interactive device identification method.

In this embodiment, by responding to the interactive command sent by the intelligent remote controller, the target orientation of the intelligent remote controller and the target operation area of the intelligent remote controller in the vehicle are determined respectively; thereby, performing matching according to the preset mapping relationship between the operation area and the device area in the vehicle, to obtain the valid device area of the intelligent remote controller in the target operation area; the target device area of the intelligent remote controller is determined from the valid device area according to the target orientation; and the interactive device in the target device area is determined as the target device, and the target device is controlled to respond to the interactive command. Through the providing of the intelligent remote controller, users at various positions in the vehicle can interact with the interactive devices in the vehicle, which improves the convenience of human-vehicle interaction, especially the interaction in multi-passengers scenarios, can meet the interactive needs of passengers at various positions in the vehicle, and can improve the user experience; and the device areas where the interactive devices in the vehicle (for example, air conditioners, windows, multimedia, etc. in the vehicle) are respectively located and the operation areas where the user is located, are obtained by pre-dividing the vehicle into spatial areas; thereby performing matching according to the preset mapping relationship between the operation area and the device area in the vehicle to obtain the valid device area of the intelligent remote controller in the target operation area; the controllable interactive devices of the intelligent remote controller located in different operation areas of the vehicle are restricted, to avoid such a case, for example, that traffic accidents occur because the passenger controls the vehicle's mirror through the intelligent remote controller, ensuring driving safety while meeting user interaction needs; and furthermore, the target device area is determined according to the orientation of the intelligent remote controller to further accurately identify the target device from a plurality of interactive devices in the vehicle; the target device is identified according to the orientation of the intelligent remote controller when the intelligent remote controller sends interactive commands, which can avoid device recognition failures due to obstruction of infrared signals or other light signals by passengers or other obstructions, thereby increasing the accuracy of vehicle interactive device recognition; through the interaction between the control terminal and the intelligent remote controller, the interaction with each interactive device in the vehicle can be achieved without need to install command receivers on each interactive device of the vehicle separately, and thereby reducing the vehicle implementation cost.

Further, based on the above first embodiment, a second embodiment of the vehicle interactive device identification method of the present disclosure is proposed. In this embodiment, before the in response to an interactive command sent by an intelligent remote controller, determining a target orientation and a target operation area located in a vehicle for the intelligent remote controller respectively in step S10, the method further includes:

Step A10, identifying interactive devices in the vehicle;

Vehicle information, including interactive devices on the vehicle, device size, device location, vehicle size, etc., is obtained; and then a plurality of interactive devices comprised in the vehicle are identified.

Step A20, dividing the vehicle into a plurality of device areas according to spatial position of each of the interactive devices in the vehicle.

The spatial position of each of the interactive devices in the vehicle is determined, and the vehicle is divided into a plurality of device areas according to the spatial position of each of the interactive devices.

In a feasible implementation, the areas where the interactive devices are located in the vehicle can be divided according to functional dimensions, to obtain a plurality of device areas; wherein the device areas of the vehicle may include: one or more of multimedia area, air-conditioning area, rearview mirror area, glove box area, ambient light area, reading light area, sunroof area, seat area, window area and trunk area.

Optionally, the device areas divided according to the functional dimension can be further divided according to the position of the interactive devices in the vehicle. The multimedia area includes: the front multimedia console area and the rear multimedia area (left, right and top); the air-conditioning area includes: the front air-conditioning area and the rear air-conditioning area; the rearview mirror area includes: the outside side rearview mirror areas (left and right) and the inner rearview mirror area; the reading light area includes: the front reading light areas and the rear reading light areas (left, center, and right), etc.; this embodiment does not impose any restrictions on this, and the actual size boundary of each of the device areas can be determined after actual vehicle calibration.

Exemplarily, referring to FIG. 4, the device areas in the front cabin of the vehicle include: front reading light area 11, front multimedia console area 21, first mirror 31, second mirror 32, third mirror 33, glove box area 41, first window area 51, second window area 52, first ambient light area 61 and second ambient light area 62.

In this embodiment, the interactive devices in the vehicle are identified, and then according to the spatial positions of the interactive devices in the vehicle, the vehicle is divided into device areas to obtain a plurality of device areas; the above method can be adapted to vehicles of different models comprising different interactive devices and different device layouts, thereby reducing the implementation cost.

In a feasible implementation, after the dividing the vehicle into a plurality of device areas according to spatial positions of each of the interactive devices in the vehicle in step A20, the method further includes:

Step A30, identifying a window area and a rearview mirror area in the device area;
a window area and a rearview mirror area in the device area are identified.

Optionally, the front window area and the outside side rearview mirror area in the device area are identified.

Optionally, the first front window area and the second front window area in the device area are identified, wherein the first front window area and the second front window area correspond to the left and right front windows of the vehicle respectively; the first outside side rearview mirror area and the second outside side rearview mirror area in the device area are identified, wherein the first outside side rearview mirror area and the second outside side rearview mirror area correspond to the left and right sides side mirrors on the outside of the vehicle respectively.

Step A40, determining a maximum overlapping portion of the window area overlapped with a projection in a first preset direction of the rearview mirror area, wherein the first preset direction is a direction from a cabin of the vehicle toward an outside of the vehicle; and

Step A50, modifying the window area according to the maximum overlapping portion, to prevent the rearview mirror area from being obstructed by the window area.

The window area and rearview mirror area on the same side of the vehicle are projected from the vehicle cabin toward the outside of the vehicle, and the maximum overlapping portion of the projections is determined; the window area is modified according to the maximum overlapping portion, to prevent the rearview mirror area from being obstructed by the window area when the user interacts with the interactive device.

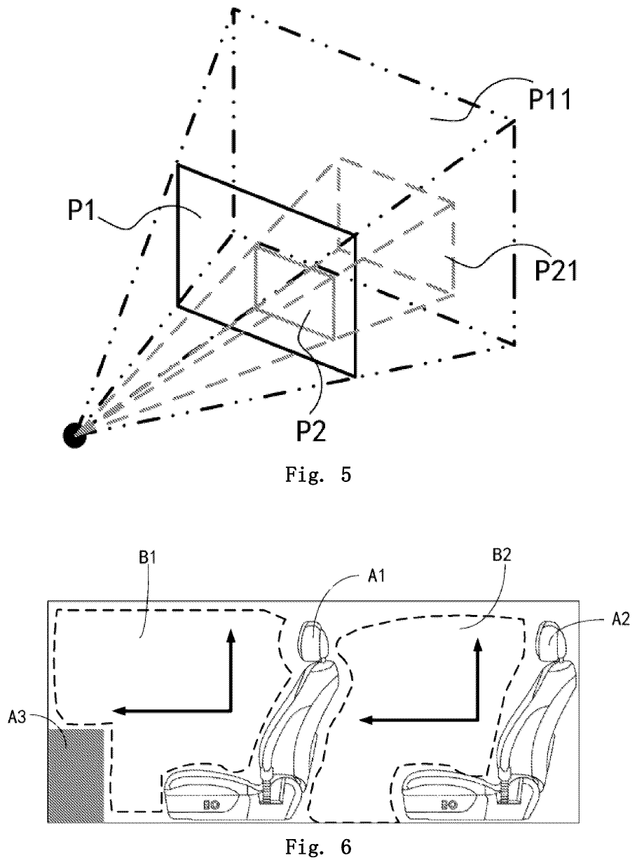

Exemplarily, referring to FIG. 5, P1 is the window area, P2 is the rearview mirror area, and P1 and P2 are projected from the vehicle cabin toward the outside of the vehicle to obtain P11 and P21 respectively; wherein P21 is the maximum overlapping portion of the projections of P1 and P2, and P2 is modified according to P21, for example, the part of the P1 area corresponding to P21 is deleted, so that the window area may not block the rearview mirror area.

In this embodiment, the window area and the rearview mirror area in the device area are identified; and then the maximum overlapping portion of the window area overlapped with a projection in a first preset direction of the rearview mirror area is determined, wherein the first preset direction is the direction from the vehicle cabin toward the outside of the vehicle; and then the window area is modified according to the maximum overlapping portion to prevent the rearview mirror area from being obstructed by the window area, so that the user in the vehicle cabin can interact with the various interactive devices of the vehicle through the intelligent remote controller, thereby improving the accuracy of interactive device recognition.

In a feasible implementation, after the dividing the vehicle into a plurality of device areas according to spatial position of each of the interactive devices in the vehicle in step A20, the method further includes:
identifying the seat area in the device area; and determining the area from the seat area to the reference area as the operation area, wherein the reference area is the closest device area in front side direction and upper side direction of the seat of the seat area. The spatial shape of the operation area can be a regular cubic area or an irregular area, which is not limited in this embodiment.

Optionally, the operation area can be further divided according to the seat area; for example, if the seat area is the driver's seat area, the operation area determined according to the driver's seat area is the driver's operation area; the operation area can be marked according to the seat area to distinguish a plurality of operation areas.

For example, referring to FIG. 6, the device area includes A1-A3 and a black block line, and the black block line can be the edge of the vehicle cabin, etc. ; wherein A1 is the first seat area, A2 is the second seat area, and A3 is the glove box area; the seat areas in the device area, i.e., A1 and A2, are identified, and thereby the reference areas corresponding to A1 and A2 are determined respectively, wherein the reference area of A1 includes: A3 located in the front side direction of the seat of Al and the left block line in FIG. 6, and the upper block line in FIG. 6 located in the upper side direction of the seat of A1; the reference area of A2 includes: A1 located in the front side direction of the seat of A2, and the upper block line in FIG. 6 located in the upper side direction of the seat of A2. The area from the seat area to the reference area is taken as the operation area to obtain the operation area B1 corresponding to Al and the operation area B2 corresponding to A2.

In a feasible implementation, the operation area of the vehicle includes: one or more of a driver's operation area, a front passenger's operation area, and a back passenger's operation area.

Optionally, the back passenger's operation area can be further divided according to the number and position of the rear seats in the vehicle; exemplarily, the vehicle is a 5-seater vehicle, including: a driver's seat, a front passenger seat and three rear passenger seats, then the three rear passenger seats can be determined as the first back passenger's operation area, the second back passenger's operation area and the third back passenger's operation area, respectively, and the first back passenger's operation area, the second back passenger's operation area and the third back passenger's operation area are all determined as the operation areas; this application is not limited to this.

In a feasible implementation, the seat area in the device area is identified; the area from the seat area to the reference area is determined as the seat operation area, and the seat operation area corresponding to each seat area is determined; thereby the remaining area in the vehicle cabin can be determined as a public operation area, and the seat operation area and the public operation area are both determined as the operation area to realize the division of the operation area in the vehicle cabin; wherein the area in the vehicle cabin except the divided device area and operation area is determined as the remaining area.

Exemplarily, referring to FIG. 7, the device areas of the vehicle include: a sunroof area 100, a first window area 101, a second window area 102, a first seat area 103 and a second seat area 104; the seat areas in the device area, that is, 103 and 104, are identified; the area from the seat area to the reference area is determined as the seat operation area to obtain C1 and C2, and the seat operation area corresponding to each seat area is determined, namely the first seat operation area C1 corresponding to the first seat area 103, and the second seat operation area C2 corresponding to the second seat area 104; the area in the cabin except for the divided device area and operation area, namely the remaining area, is determined as the public operation area C3, and thereby C1, C2 and C3 are all determined as operation areas.

Further, based on the above-mentioned first and/or second embodiments, a third embodiment of the vehicle interactive device identification method of the present disclosure is proposed. In this embodiment, step S30, the determining a target device area of the intelligent remote controller from the valid device area according to the target orientation includes:

Step S31, generating a first orientation ray according to the target orientation; and

Step S32, determining a valid device area through which the first orientation ray passes and having a shortest distance from a starting point of the first orientation ray, as the target device area.

An orientation ray (hereinafter referred to as the first orientation ray in order for distinction) is generated according to the target orientation of the intelligent remote controller; and the valid device area through which the first orientation ray passes is determined, and then a valid device area which has a shortest distance from a starting point of the first orientation ray among the valid device area through which the first orientation ray passes, that is, the first valid device area through which the first orientation ray passes at first, is determined as the target device area. If the first orientation ray extends outside the vehicle and still does not pass through the valid device area, it is determined that the target device area recognition fails.

Optionally, the condition “shortest distance” when determining the target device area can be replaced with other conditions as needed. For example, the valid device area through which the first orientation ray passes and having a farthest distance from a starting point of the first orientation ray, or within a preset distance range, is determined as the target device area, etc. This embodiment does not make any limitations in this regard.

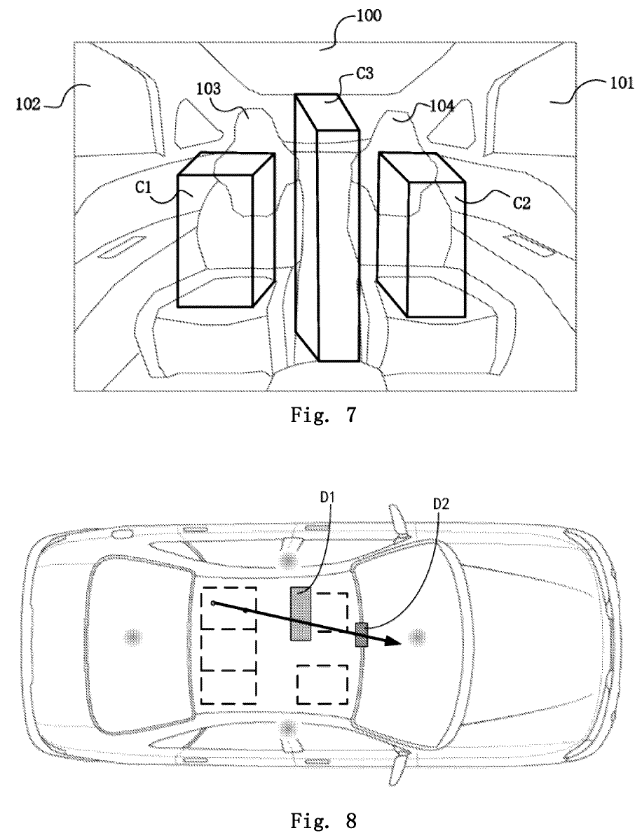

Exemplarily, referring to FIG. 8, the gray squares D1 and D2 are the valid device areas of the intelligent remote controller; thereby, a first orientation ray is generated according to the target orientation, and it is determined that the valid device area through which the first orientation ray passes includes D1 and D2, wherein D1 has a shortest distance from the starting point of the first orientation ray, that is, D1 is the target device area.

In this embodiment, a first orientation ray is generated according to the target orientation; and a valid device area through which the first orientation ray passes and having the shortest distance from a starting point of the first orientation ray is determined as the target device area, so as to achieve accurate identification of the area where the target device for interacting with the intelligent remote controller is located, thereby improving the convenience of human-vehicle interaction, especially the interaction in multi-passengers scenarios, being able to meet the interaction needs of passengers in various positions of the vehicle, and improving the user experience.

In a feasible implementation, before the step S31, that is, the generating a first orientation ray according to the target orientation, the method further includes:

Step S33, determining whether the target orientation is consistent with a preset seat adjustment direction;

Step S34, if not, performing the generating a first orientation ray according to the target orientation;

It is determined whether the target orientation of the intelligent remote controller is consistent with the preset seat adjustment direction; if not, the generating a first orientation ray according to the target orientation and subsequent operations are performed.

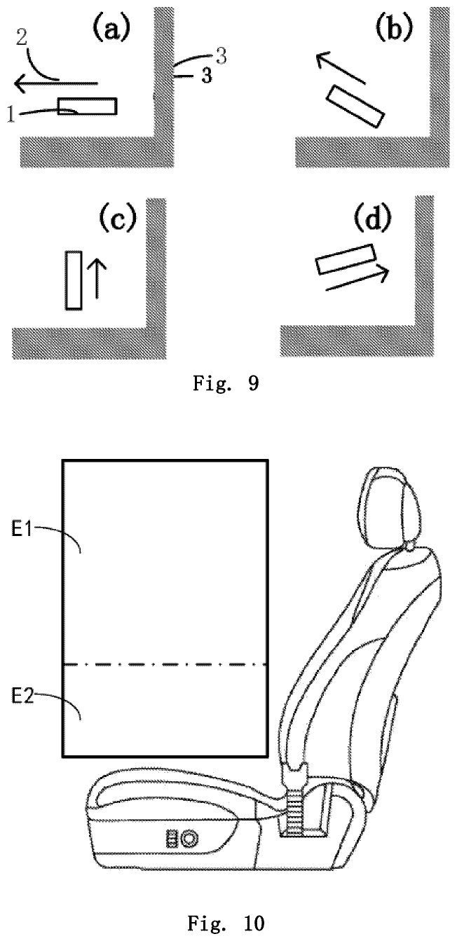

Exemplarily, referring to FIGS. 9, 1 is the intelligent remote controller, 2 is the target orientation of the intelligent remote controller, and 3 is the seat area in the device area; FIG. 9(a) to FIG. 9(d) are preset seat adjustment directions; since the adjustable directions of the seats in the vehicle cabin include: front and rear position adjustment in the direction parallel to the floor, that is, FIG. 9(a); up and down position adjustment in the direction perpendicular to the floor, that is, FIG. 9(b); and the inclination angle of the seat back, that is, FIG. 9(b) and (d); therefore, preset seat adjustment directions are set according to the adjustable directions of the seats.

Step S35, if yes, generating two second orientation rays by extending bidirectionally based on the target orientation when the intelligent remote controller is located in a seat adjustment area in the target operation area, wherein the two second orientation rays have the same starting point;

If yes, it indicates that the user may have a need to interact with the seat in the interactive device, then it is determined whether the intelligent remote controller is in the seat adjustment area in the target operation area; wherein, there are a plurality of operation areas in the vehicle, for example, the operation area includes: one or more of the driver's operation area, the front passenger's operation area and the back passenger's operation area. Each operation area can be provided with one seat adjustment area in advance, so that the user can quickly select the seat in the interactive device to perform seat adjustment. If the intelligent remote controller is not located in the seat adjustment area in the target operation area, then the generating a first orientation ray according to the target orientation is performed; if the intelligent remote controller is located in the seat adjustment area in the target operation area, then based on the target orientation, two orientation rays (hereinafter referred to as the second orientation ray in order for distinction) are generated by performing bidirectional extension from the same starting point.

Optionally, in the operation area corresponding to each seating area, the area within a preset distance toward the upper side of the seat with the seat of the seating area as the starting position, is determined as the seat adjustment area in the operation area; exemplarily, the seat adjustment area is the area close to the passenger's thigh in the driver's operation area, the front passenger's operation area or the back passenger's operation area of the operation area; by dividing the seat adjustment area in each operation area, it is convenient for users to quickly select the seat in the interactive device to adjust the seat.

Exemplarily, referring to FIG. 10, E1 is the operation area, and E2 is the seat adjustment area preset in the E1; if the intelligent remote controller is located in E1, and the target orientation of the intelligent remote controller is consistent with the preset seat adjustment direction, then a bidirectional extension is performed based on the target orientation to generate two second orientation rays.

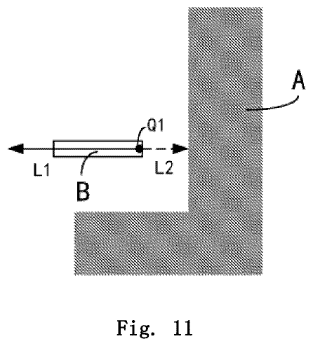

Exemplarily, referring to FIG. 11, A is the seat area, and B is the intelligent remote controller; Q₁ is the starting point in the target orientation; if the target orientation of the intelligent remote controller is consistent with the preset seat adjustment direction, and the target operation area where the intelligent remote controller is located is the preset seat adjustment area, then bidirectional extension is performed with Q₁ as the starting point to obtain two second orientation rays L1 and L2; if the target orientation of the intelligent remote controller is inconsistent with the preset seat adjustment direction, and/or the target operation area where the intelligent remote controller is located is not the preset seat adjustment area, then one first orientation ray L1 is obtained with Q₁ as the starting point.

Step S36, determining a valid device area through which the second orientation rays pass and having a shortest distance from the starting point of the second orientation rays, as the target device area.

The valid device area through which the two second orientation rays pass and which have the shortest distance from the starting point of the second orientation ray is determined as the target device area.

In this embodiment, when the user adjusts the seat, the user may unconsciously put the intelligent remote controller in the direction consistent with the seat adjustment direction; for example, the user holds the intelligent remote controller to parallel to the floor and toward the front of the vehicle, and then adjusts the seat forward (towards the front of the vehicle); at this time, if a first orientation ray is generated according to the target orientation of the intelligent remote controller to identify the target device, the seat may not be identified; therefore, after determining the target orientation, it is determined whether the target orientation is consistent with the preset seat adjustment direction to determine whether the target device may be a seat; and if so, then, when the intelligent remote controller is located in a seat adjustment area in the target operation area, bidirectional extension is performed based on the target orientation to generate two second orientation rays; the operation area corresponding to each seat area is provided with one seat adjustment area in advance, the seat adjustment area is used to quickly adjust the seats in the interactive device; and because the user will unconsciously move the intelligent remote controller close to the target device when interacting with the interactive device through the intelligent remote controller, therefore, if the intelligent remote controller meets the above requirements, it indicates that the possibility that the target device is a seat is high, and in order to prevent the user from putting the intelligent remote controller towards a side far away from the seat due to usage habits, bidirectional extension is performed based on the target orientation to generate two orientation rays in opposite directions, so as to accurately identify the target device area and improve the accuracy of target device recognition.

Furthermore, the embodiment of the present disclosure also provides a vehicle interactive device identification system, the vehicle interactive device identification system includes an intelligent remote controller and a control terminal, the intelligent remote controller is communicatively connected with the control terminal, and the vehicle interactive device identification system includes:
the intelligent remote controller configured to transmit an interactive command to the control terminal in response to a user's operation;

Optionally, at least one positioning device is provided at each of the front and rear ends of the intelligent remote controller, and the identification numbers of the positioning devices are different.
the control terminal is configured to: in response to an interactive command sent by an intelligent remote controller, determine a target orientation and a target operation area located in the vehicle for the intelligent remote controller respectively; perform matching according to a preset mapping relationship between an operation area and a device area in the vehicle, to obtain a valid device area of the intelligent remote controller in the target operation area; determine a target device area of the intelligent remote controller from the valid device area according to the target orientation; and determine an interactive device in the target device area as a target device and control the target device to respond to the interactive command.

Optionally, the control terminal is further used to identify the interactive device in the vehicle and to divide the vehicle into a plurality of device areas according to spatial positions of each of the interactive devices in the vehicle.

Optionally, the control terminal is also used to, identify a window area and a rearview mirror area in the device area, to determine a maximum overlapping portion of the window area being overlapped a projection in a first preset direction of the rearview mirror area, wherein the first preset direction is a direction from a cabin of the vehicle toward an outside of the vehicle, and to modify the window area according to the maximum overlapping portion to prevent the rearview mirror area from being obstructed by the window area.

Optionally, the device area of the vehicle includes: one or more selected from a group consisting of: a multimedia area, an air-conditioning area, a rearview mirror area, a glove box area, an ambient light area, a reading light area, a sunroof area, a seat area, a window area and a trunk area.

Optionally, the operation area of the vehicle includes: one or more selected from a group consisting of a driver's operation area, a front passenger's operation area and a back passenger's operation area.

Optionally, the control terminal is further used to generate a first orientation ray according to the target orientation, and to determine the valid device area through which the first orientation ray passes and having a shortest distance from a starting point of the first orientation ray, as the target device area.

Optionally, the control terminal is further used to: determine whether the target orientation is consistent with a preset seat adjustment direction; if not, the control terminal performs the step of generating a first orientation ray according to the target orientation; if yes, the control terminal performs the step of generating two second orientation rays by extending bidirectionally based on the target orientation when the intelligent remote controller is located in a seat adjustment area in the target operation area, wherein the two second orientation rays have the same starting point; and to determine the valid device area through which the second orientation rays pass and having a shortest distance from the starting point of the second orientation rays, as the target device area.

Optionally, the control terminal is also used to acquire coordinate information of each of the positioning devices, wherein the coordinate information encapsulates the identification numbers of the positioning devices; to determine the target operation area where the intelligent remote controller is located according to the coordinate information; and to determine a front point and a rear point of the intelligent remote controller according to the coordinate information, and determine a direction from the rear point to the front point as the target orientation.

It should be noted that, in this article, the terms “include”, “comprise” or any other variations thereof are intended to cover non-exclusive inclusion, so that a process, method, article or system including a series of elements includes not only those elements, but also other elements not explicitly listed, or also includes elements inherent to such process, method, article or system. In the absence of further restrictions, an element defined by the sentence “comprises a . . .” does not exclude the presence of other identical elements in the process, method, article or system including the element.

Through the description of the above implementation methods, those skilled in the art can clearly understand that the above-mentioned embodiment methods can be implemented by means of software and a necessary general hardware platform, and of course by hardware, but in many cases the former is a better implementation method. Based on such an understanding, the technical solution of the present disclosure is essentially or the part that contributes to the related art can be embodied in the form of a software product, which is stored in a storage medium (such as ROM/RAM, magnetic disk, optical disk) as described above, and includes a number of instructions for a terminal device (which can be a mobile phone, computer, server, or network device, etc.) to execute the methods described in each embodiment of the present disclosure.

The above are only preferred embodiments of the present disclosure, and are not intended to limit the patent scope of the present disclosure. Any equivalent structure or equivalent process transformation made using the contents of the present disclosure specification and drawings, or directly or indirectly applied in other related technical fields, are also included in the patent protection scope of the present disclosure.

1. A vehicle interactive device identification method, applied to a control terminal, wherein the vehicle interactive device identification method comprises following steps:
in response to an interactive command sent by an intelligent remote controller, determining a target orientation and a target operation area located in a vehicle for the intelligent remote controller respectively;
performing matching according to a preset mapping relationship between an operation area and a device area in the vehicle, to obtain a valid device area of the intelligent remote controller in the target operation area;
determining a target device area of the intelligent remote controller from the valid device area according to the target orientation; and
determining an interactive device in the target device area as a target device, and controlling the target device to respond to the interactive command.

2. The vehicle interactive device identification method according to claim 1, wherein, before the responding to the interactive command sent by the intelligent remote controller, the method further comprises:
identifying interactive devices in the vehicle; and
dividing the vehicle into a plurality of device areas according to spatial positions of each of the interactive devices in the vehicle.

3. The vehicle interactive device identification method according to claim 2, wherein after the dividing the vehicle into the plurality of device areas according to spatial positions of each of the interactive devices in the vehicle, the method further comprises:
identifying a window area and a rearview mirror area in the device area;
determining a maximum overlapping portion of the window area being overlapped with a projection in a first preset direction of the rearview mirror area, wherein the first preset direction is a direction from a cabin of the vehicle toward an outside of the vehicle; and
modifying the window area according to the maximum overlapping portion to prevent the rearview mirror area from being obstructed by the window area.

4. The vehicle interactive device identification method according to claim 1, wherein the device area of the vehicle comprises one or more selected from a group consisting of: a multimedia area, an air-conditioning area, a rearview mirror area, a glove box area, an ambient light area, a reading light area, a sunroof area, a seat area, a window area and a trunk area.

5. The vehicle interactive device identification method according to claim 1, wherein the operation area of the vehicle comprises one or more selected from a group consisting of a driver's operation area, a front passenger's operation area and a back passenger's operation area.

6. The vehicle interactive device identification method according to claim 1, wherein the determining a target device area of the intelligent remote controller from the valid device area according to the target orientation comprises:
generating a first orientation ray according to the target orientation; and
determining a valid device area through which the first orientation ray passes and having a shortest distance from a starting point of the first orientation ray, as the target device area.

7. The vehicle interactive device identification method according to claim 6, wherein, before the generating a first orientation ray according to the target orientation, the method further comprises:
determining whether the target orientation is consistent with a preset seat adjustment direction;
if not, performing the generating a first orientation ray according to the target orientation;
if yes, generating two second orientation rays by extending bidirectionally based on the target orientation when the intelligent remote controller is located in a seat adjustment area in the target operation area, wherein the two second orientation rays have the same starting point; and
determining a valid device area through which the second orientation rays pass and having a shortest distance from the starting point of the second orientation rays, as the target device area.

8. The vehicle interactive device identification method according to claim 1, wherein at least one positioning device is provided at each of front and rear ends of the intelligent remote controller, and identification numbers of the positioning devices are different from each other, and wherein the determining a target orientation and a target operation area located in a vehicle for the intelligent remote controller respectively comprises:
acquiring coordinate information of each of the positioning devices, wherein the coordinate information contains the identification numbers of the positioning devices;
determining the target operation area where the intelligent remote controller is located according to the coordinate information; and
determining a front point and a rear point of the intelligent remote controller according to the coordinate information, and determining a direction from the rear point to the front point as the target orientation.

9. A vehicle interactive device identification system, comprising an intelligent remote controller and a control terminal, wherein the intelligent remote controller is communicatively connected with the control terminal, wherein the vehicle interactive device identification system comprises:
the intelligent remote controller configured to transmit an interactive command to the control terminal in response to a user's operation; and
the control terminal configured to: in response to an interactive command sent by an intelligent remote controller, determine a target orientation and a target operation area located in a vehicle for the intelligent remote controller respectively; perform matching according to a preset mapping relationship between an operation area and a device area in the vehicle, to obtain a valid device area of the intelligent remote controller in the target operation area; determine a target device area of the intelligent remote controller from the valid device area according to the target orientation; and determine an interactive device in the target device area as a target device and control the target device to respond to the interactive command.

10. An intelligent remote controller, comprising: a memory, a processor, and a vehicle interactive device identification program stored in the memory and executable by the processor, wherein the vehicle interactive device identification program is configured to implement the steps of the vehicle interactive device identification method according to claim 1.

11. A storage medium having a vehicle interactive device identification program stored thereon, the vehicle interactive device identification program is executed by a processor to implement the steps of the vehicle interactive device identification method according to claim 1.
